(19) United States
(12) Patent Application Publication
(10) Pub. No.: US 2003/0061180 A1
(43) Pub. Date: Mar. 27, 2003

(54) Process for establishing privileged commercial relationships between a supplier and at least one customer, and an AD HOC supply system

(76) Inventors: Pascal Arriulou, Saint Maurice (FR); Emmanuel Pousset, Paris (FR)

Correspondence Address: Linda K. Russell, Suite 1800, 2700 Post Oak Blvd, Houston, TX, 77056, US

(21) Appl. No.: 10/253,178

(22) Filed: Sep. 24, 2002

(30) Foreign Application Priority Data
Sep. 24, 2001 (EP) 01 402 439.2

(51) Int. Cl. G06F 17/60

(52) U.S. Cl. 705/412; 705/1

(57) ABSTRACT

A decision making unit (1), coupled to a command unit (G) of a processing unit (U) elaborating an industrial product (B), typically an industrial fluid, detects, in response to external data (SD, RI, 5, 3), temporary production overcapacities and transmits on line to potential customers (C) messages informing same of the temporary availability of specific quantities of said goods under special terms and conditions, and records the customer's order placed in response thereto by the same Internet (I) or electronic mail (5) connections.

This invention relates to the offer for sale and the supply, under specific conditions, of processed goods, advantageously industrial fluids, between a supplier of said goods and a customer connected to the supplier via at least one industrial fluid transfer line.

In the domain of industrial fluids such as gas, vacuum, or electricity, the supplier, associated with a certain number of customers by supply contracts for given quantities of fluids over determined periods of time under specific terms and conditions, scales his production unit and/or sel<ects sources of supply as a function of the quantities forecast to be supplied pursuant to said contracts. Nevertheless, the supplier frequently finds himself with spot reserves of production capacities resulting from temporary slumps in consumption by certain customers, or stoppages, likewise temporary, of consumption by certain customers, particularly the consequence of maintenance operations.

An object of the invention is to provide a process and a system for establishing temporary commercial relationships between the supplier and a potential buying customer allowing the former to provide customers with real-time information on production overcapacity opportunities and related supplies of such surplus goods under temporary preferred conditions.

In order to do this, according to a feature of the invention, the process of establishing preferred temporary commercial relationships between a supplier of processed goods and at least one potential buying customer of at least one of said goods connected to the supplier via at least one two-way information transmission system, comprises the following steps:

detection by the supplier of a production overcapacity of at least on of said goods over an initial predetermined period,

emission by the supplier, over the transmission system during a second predetermined period, of a message addressed at least to one potential buying customer informing the latter of a temporary availability of at least one of said goods under special terms and conditions,

emission by the customer, over the transmission system during said second predetermined period, of a message addressed to the supplier, of acceptance of delivery of a quantity certain of said goods under said terms and conditions over at least one third period included in said first period.

A further object of this invention is to provide a system for at least temporarily supplying processed goods to a customer for implementation of the foregoing process, comprising, on the side of the supplier, at least one processing unit having a control unit and at least one supply outlet for delivery processed goods, and a decision making unit responsive to the input signals and comprising a two-way interface for the outgoing transmission and receipt of incoming messages, the decision making unit being connected to the control unit in order to control the processing unit in response to signals coming from the two-way interface.

The invention is more completely explained with reference to the following description of a particular embodiment, being illustrative not limiting, read together with the attached drawing, wherein:

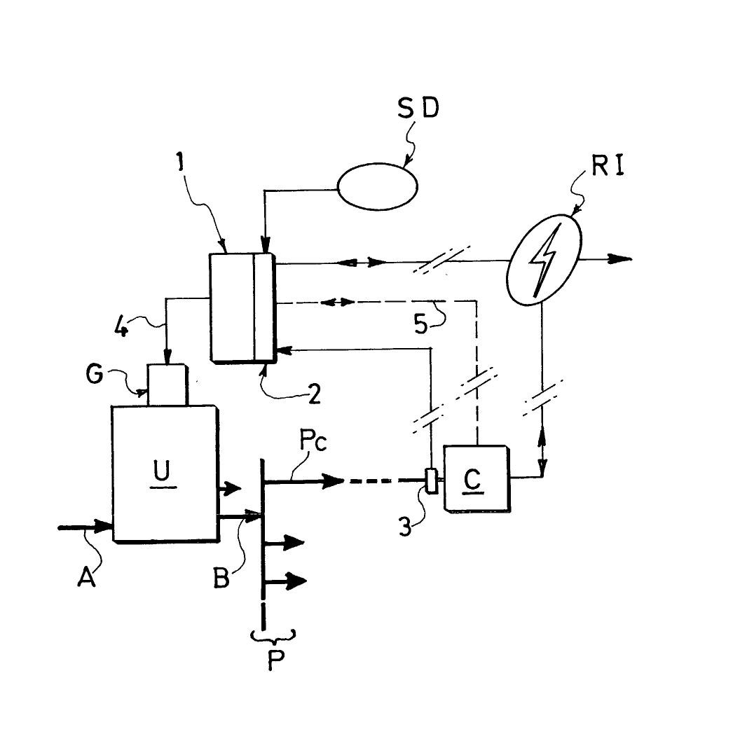

FIG. 1 is a representation of an exemplary embodiment of the system for implementation of a process according to the invention.

In the particular embodiment represented in FIG. 1, focusing on the supply of gas by means of a pipeline network, a processing unit U of a raw material A, for example air, and at least one processed material B, a gas occurring in air such as oxygen, nitrogen or argon for example, is represented. The gas B is routed by a pipeline P_{c} to a customer C. The processing unit U is controlled by a command post G.

According to the invention, the supplier has available a decision making unit 1 based on the different incoming signals handled by a two-way interface 2. Said signals are namely the measurement signals of the quantities of gas consumed picked up by a sensor 3 on the line P_{c} of customer C and information coming from a data system SD relevant to vacation periods, reduced production or maintenance at other customers of the network P. These signals are analyzed in the unit 1 by data processing software based on updateable business models.

Based on the signals received, the decision making unit 1, coupled to the command post G by a line 4, allows either temporary reduction of production by the unit U or determination regarding at least one specific period, of the production overcapacities that would be offered on line in supply to different customers of the network P under specific terms and conditions, including the forecast overcapacities and the actual production costs at the time of said specific period.

According to one aspect of the invention, this offer of supply of goods under specific terms and conditions is transmitted in real time to customers over the two-way interface 2 over the Internet RI and/or by electronic messaging connections 5 established directly between the supplier and certain of its customers over a fixed telephone lines, mobile phone or pager or SMS/Texto over mobile telephones.

If a customer is interested in all or part of an offer, he sends by the same means of the Internet RI or by the messaging system 5, an acceptance message for a quantity certain of said goods under the promised special terms and conditions; this “order” being confirmed by the transmission, at all times by the same means of communication, by the supplier with a delivery agreement message.

In one particular embodiment, if the customer C has at his disposal a decision making unit with a two-way interface of the unit 1 type, the supply of goods under the specified conditions can be automated as a function of several criteria or parameters such as the price level of the goods, concomitance of the customer's requirements and the availability of the product in the desired quantities at the supplier's.

As can be understood from a reading of the foregoing description, the solution proposed herein allows real-time transmission of immediate and systematic information to different customers and the opportunity also for the latter to respond positively and immediately by taking advantage of the supply guarantee by acceptance of the order without having to be placed on any eventual waiting list. On the other hand, the automatic transmission of offers to different customers allows the supplier to acquire additional information on the needs of the respective customers and to accordingly adjust his production tools.

Whatever the invention may have described in relation to a particular embodiment, it is not limiting in character but may be subject to modifications and variants that will appear obvious to the specialist in the scope of the below claims.

1. A process for establishing preferred temporary commercial relationships between a supplier of processed goods and at least one potential customer buyer of at least one of said goods connected to the supplier by at least one two-way information transmission system, comprising the following steps:
a) detection by the supplier of a production overcapacity of at least one of said goods during a first determined period;
b) emission by the supplier over the transmission system, during a second determined period, of a message addressed at least to the potential customer buyer informing him of a temporary availability of at least one of said goods under special terms and conditions;
c) emission by the customer over the transmission system to the supplier during said second determined period of a message accepting the delivery of a certain quantity of said goods under said special terms and conditions during at least a third period included in said first period, and
d) emission by the supplier to the customer of a message agreeing to deliver said quantity of said goods under the agreed terms and conditions.

2. A process according to claim 1, further comprising the final step e) of supply of said goods by the supplier to the customer during said third period.

3. A process according to claim 1 or 2, wherein the messages are exchanged with the buyer customers via Internet connection.

4. A process according to claim 1 or 2, wherein the messages are exchanged with a regular customer by electronic mail via a fixed telephone line, mobile phone or pager.

5. A process according to one of the foregoing claims, wherein the processed good is an industrial fluid.

6. A process according to claim 5, wherein the customer is connected to the supplier by at least one transfer line of said industrial fluid.

7. A process according to claim 6, where in step a) includes a measurement of the quantity of good supplied to at least one customer.

8. A process according to claim 6 or 7, wherein step a) includes the receipt of information transmitted by the customer.

9. A process according to one of claims 6 to 8, wherein steps c) to e) are done in an automated fashion.

10. A system for at least temporarily supplying processed goods to a customer for implementation of the process according to one of the preceeding claims, comprising, at the supplier's side, at least one processing unit (U) having a command unit (G) and at least one delivery outlet for processed goods, and a decision making unit (1) responsive to incoming signals (SD, 5, 3) and comprising a two-way interface (2) for transmitting outgoing messages and for receiving incoming messages, the decision making unit (1) being connected to the command unit (G) for controlling the processing unit (U) in response to signals from the two-way interface (2).

11. A system according to claim 10, for the supply of at least one industrial fluid (B), comprising at least one transfer line (P_{c}) between the exit from the processing unit (U) and at least one customer (C).
